(19) United States
(12) Patent Application Publication
(10) Pub. No.: US 2015/0246850 A1
(43) Pub. Date: Sep. 3, 2015

(54) ALUMINA NANOFIBER REINFORCED CEMENT-BASED MATERIALS AND METHOD FOR PRODUCING SAME

(71) Applicant: ANF TECHNOLOGY LIMITED, Warlingham (GB)

(72) Inventor: Ilya Grodnensky, Foster City, CA (US)

(21) Appl. No.: 14/194,635

(22) Filed: Feb. 28, 2014

(51) Int. Cl. C04B 14/48

(52) U.S. Cl. CPC C04B 14/48

(57) ABSTRACT

A method and apparatus for producing a cement-based material, such as concrete, mortar and/or grout reinforced by unidirectionally oriented pre-dispersed alumina nanofibers, as well as the resulting material. The aforesaid process is well suited for industrial-scale production of the cement-based composite materials. The resulting nanomaterial is composed of the cement base, various additives and homogeneously dispersed uniformly oriented reinforcing alumina nanofibers. In various embodiments, the aforesaid composite material may be manufactured by means of water-dispersion of the alumina nanofibers and combining the resulting dispersed nanofiber solution with the cement base and, if applicable, one or more additives. Additionally or alternatively, the alumina nanofibers with or without the cement base may be subject to mechanical or/and ultrasound coarse dispersing. Finally, the resulting nanocomposite material is subjected to the conventional fabrication techniques to manufacture the final composite product.

### BACKGROUND OF THE INVENTION

1. Field of the Invention

This described embodiments relate in general to nano technology and, more specifically, to cement-based materials, such as concrete, mortar and/or grout, reinforced with alumina nanofibers and to techniques for producing same.

2. Description of the Related Art

Nanotechnology deals with developing materials, devices, or other structures having at least one dimension sized between 1 and 100 nanometers. Nanoparticles are the particles having at least one dimension sized between 1 and 100 nanometers. On the other hand, nanofibers are defined as fibers with diameters less than 1000 nanometers. Nanofibers are widely used for manufacturing of various nanocomposite materials having enhanced properties, such as polymers reinforced by nanoparticles.

One of the potential uses for the nanofibers is enhancing tensile and compression properties of cement-containing materials, such as concrete, mortar and grout. At the present time, carbon nano tubes (CNT) have been successfully used to enhance mechanical properties of cement-containing materials. However, because the toxicity of CNT is largely unknown, many countries treat CNT-containing building materials like asbestos, which greatly limits their practical use. In addition, no significant improvement in tensile strength of cement-containing materials treated with CNTs has been observed.

It should be further noted that due to their large surface area, nanofibers such as carbon nanotubes tend to agglomerate during the production process of nanocomposite materials. On the other hand, in the agglomerated state, many of the beneficial properties of the nanofibers and, in particular, their reinforcing ability, are compromised. This leads to only marginal improvements in the properties of nanofiber-reinforced cement-containing materials compared to the conventional materials.

Thus, new and improved techniques for manufacturing of cement-containing materials reinforced with nanoparticles are needed.

### SUMMARY OF THE INVENTION

The inventive methodology is directed to methods and systems that substantially obviate one or more of the above and other problems associated with conventional techniques for manufacturing nanofiber-reinforced cement-based materials.

In accordance with one aspect of the embodiments described herein there is provided a method for producing a cement-based material reinforced by co-oriented alumina Al₂O₃ nanofibers, the method comprising combining a plurality of co-oriented alumina Al₂O₃ nanofibers with a cement base.

In one or more embodiments, the method further comprises subjecting the combined co-oriented alumina Al₂O₃ nanofibers and the cement base to an ultrasound to facilitate dispersion of the alumina Al₂O₃ nanofibers.

In one or more embodiments, the method further comprises adding one or more additives to the combined co-oriented alumina Al₂O₃ nanofibers and the cement base.

In one or more embodiments, the cement-based material is a concrete.

In one or more embodiments, the cement-based material is a mortar.

In one or more embodiments, the cement-based material is a grout.

In one or more embodiments, combining a plurality of co-oriented alumina Al₂O₃ nanofibers with a cement base comprises water-dispersing the a plurality of co-oriented alumina Al₂O₃ nanofibers and combining the resulting dispersion with the cement base.

In one or more embodiments, combining a plurality of co-oriented alumina Al₂O₃ nanofibers with a cement base comprises mechanical mixing the plurality of co-oriented alumina Al₂O₃ nanofibers with the cement base.

In accordance with another aspect of the embodiments described herein there is provided a cement-based material reinforced by co-oriented alumina Al₂O₃ nanofibers prepared by a process comprising combining a plurality of co-oriented alumina Al₂O₃ nanofibers with a cement base.

In one or more embodiments, the method further comprises subjecting the combined co-oriented alumina Al₂O₃ nanofibers and the cement base to an ultrasound to facilitate dispersion of the alumina Al₂O₃ nanofibers.

In one or more embodiments, the method further comprises adding one or more additives to the combined co-oriented alumina Al₂O₃ nanofibers and the cement base.

In one or more embodiments, the cement-based material is a concrete.

In one or more embodiments, the cement-based material is a mortar.

In one or more embodiments, the cement-based material is a grout.

In one or more embodiments, combining a plurality of co-oriented alumina Al₂O₃ nanofibers with a cement base comprises water-dispersing the a plurality of co-oriented alumina Al₂O₃ nanofibers and combining the resulting dispersion with the cement base.

In one or more embodiments, combining a plurality of co-oriented alumina Al₂O₃ nanofibers with a cement base comprises mechanical mixing the plurality of co-oriented alumina Al₂O₃ nanofibers with the cement base.

In accordance with another aspect of the embodiments described herein there is provided a cement-based material reinforced by co-oriented alumina Al₂O₃ comprising a cement base combined with a plurality of co-oriented alumina Al₂O₃ nanofibers.

In one or more embodiments, the cement-based material further comprising one or more additives.

In one or more embodiments, the cement-based material is a concrete.

In one or more embodiments, the cement-based material is a mortar.

In one or more embodiments, the cement-based material is a grout.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a reactor for synthesis of aluminum oxide nanofibers.

FIG. 2 illustrates an exemplary embodiment of a method for production of aluminum oxide nanofibers.

FIG. 3 illustrates a mat-like structure of the produced co-oriented pre-dispersed alumina nanofibers.

FIG. 4 illustrates an exemplary embodiment of a method for producing a cement-based nanocomposite material reinforced by unidirectionally oriented pre-dispersed alumina nanofibers.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

In accordance with one aspect of the invention, there is provided a method and apparatus for producing a cement-based material, such as concrete, mortar and/or grout reinforced by unidirectionally oriented pre-dispersed alumina nanofibers. The aforesaid process is well suited for industrial-scale production of the cement-based composite materials. The resulting nanomaterial is composed of the cement base, various additives and homogeneously dispersed uniformly oriented reinforcing alumina nanofibers. In various embodiments, the aforesaid composite material may be manufactured by means of water-dispersion of the alumina nanofibers and combining the resulting dispersed nanofiber solution with the cement base and, if applicable, one or more additives. Additionally or alternatively, the alumina nanofibers with or without the cement base may be subject to mechanical or/and ultrasound coarse dispersing. Finally, the resulting nanocomposite material is subjected to the conventional fabrication techniques to manufacture the final composite product.

In accordance with one or more embodiments of the invention, at the first step of the inventive process, monocrystalline alumina nanofibers are produced by controlled liquid phase oxidation of aluminum. In one or more embodiments, the alumina nanofibers synthesis method comprises two stages. During the first stage, various additives are introduced into molten metallic aluminum. During the second stage, the alumina nanofibers are synthesized from the resulting melt in the presence of oxygen. In one or more embodiments, the inventive method is performed in a reactor.

Subsequently, at the second process step, the manufactured alumina nanofibers are combined with a cement base and, if applicable, the additive(s). Upon drying, the resulting cement-based nanocomposite material reinforced by alumina nanofibers is produced. In one or more embodiments, the alumina nanofibers act to enhance mechanical, thermal, optical and electrical properties of the cement base.

The aforesaid two steps of the inventive nanocomposite material synthesis process will now be described in detail. It should be noted that the below description primarily deals with alumina nanofibers possessing two linear dimensions of less than 45 nm. Because the nanofibers described herein have circular cross section, the size of the nanofiber will be specified below by reference to its diameter.

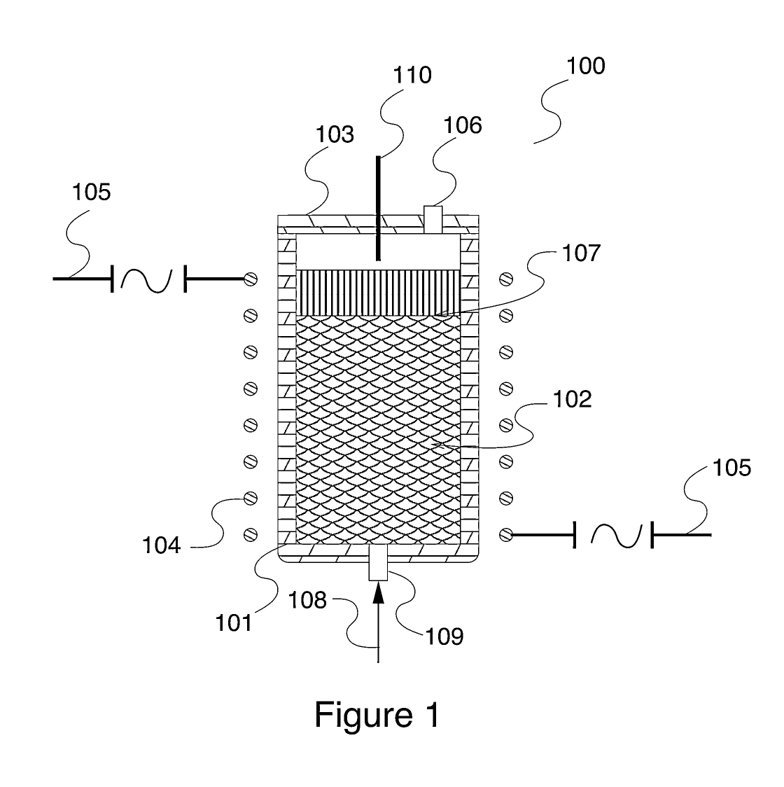

In accordance with one or more embodiments of the invention, the alumina nanaofibers are produced in a reactor. The aforesaid reactor is designed to provide the heating and enable melting of the aluminum. An exemplary embodiment of the reactor 100 is illustrated in FIG. 1. The shown embodiment of the reactor 100 incorporates reactor body 101 enclosing a reaction chamber, which contains the melt 102. The reactor 100 is closed from the top using cover 103, which may incorporate one or more sensor assembly 110 for monitoring various parameters inside the reactor 100, including, without limitation, temperature, pressure and oxygen content. The reactor cover 103 may also incorporate one or more valve assemblies 106 for controlling the atmosphere inside the reactor. In addition, an inlet 109 may be provided in the bottom part of the reactor 100 for injecting various additives and oxygen into the reactor 100, see numeral 108. In one or more embodiments, the content of the reactor may be heated using a suitable induction heating mechanism, which may incorporate induction coil 104 electrically connected to an electric current source 105. The zone of synthesis of aluminum oxide nanofibers is marked in Figure with numeral 107. The oxygen content inside the reactor 100 may be automatically monitored and/or altered using control logic.

In one or more embodiments, the reactor is designed to maintain a sustained temperature of between 660° C. and 1,000° C. When the additives described below are introduced into the molten aluminum, it is desirable to provide steady and uniform the stirring of the melt. To this end, the aforesaid reactor may be provided with a stirring mechanism (not shown in FIG. 1). The construction of the reactor should also provide control over gas composition of the atmosphere during both the introduction of the additives and during the synthesis of the nanofibers. In one or more embodiments, the oxygen content of the atmosphere should be 0.00001 wt. % (weight percent) to 99.9 wt. % depending on the stage of the synthesis process.

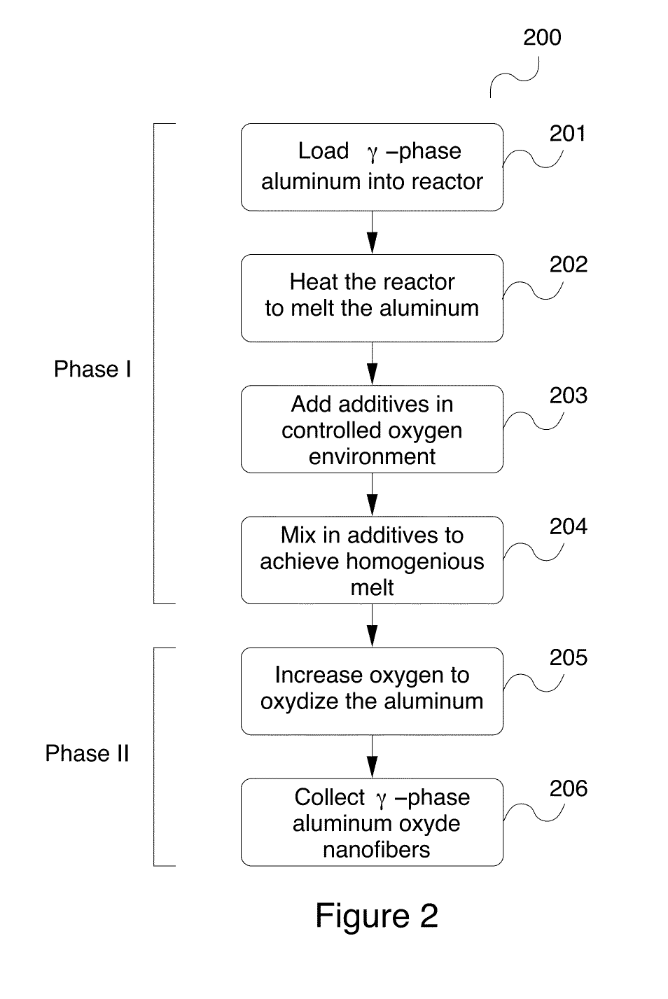

FIG. 2 illustrates an exemplary embodiment of the inventive method 200 for production of aluminum oxide nanofibers. In accordance with one or more embodiments of the invention, during the first, additive introduction phase (Phase I in FIG. 2) of the inventive process 200, the oxygen content of the atmosphere is kept to the minimal oxygen concentration. On the other hand, during the second, synthesis stage (Phase II in FIG. 2), the oxygen content should be higher, depending on the temperature and the required speed of the nanofiber synthesis process.

In accordance with one or more embodiments of the invention, the heating of the melt is performed using induction heating or electrical resistance heating (ERH, also known as electrical resistive heating) methods, which are well known to persons of ordinary skill in the art. To this end, the reactor may incorporate an appropriate heater. However, the present invention is not limited only to the aforesaid induction heating or electrical resistance heating methods and any other suitable heating method could be utilized for heating, melting and maintaining the required temperature of the material. It should be noted that the heater should preferably provide even heating of the entire volume of the material in the reactor. In addition, in one or more embodiment, the reactor incorporates means for controlling the content of the atmosphere inside the reactor. Construction and methods of application of such means are well known to persons of ordinary skill in the art.

In accordance with one or more embodiments of the invention, in order to synthesize alumina nanofibers, metallic aluminum having purity of 99.7% is first loaded into the reactor 100 in step 201 and melted in the reactor n step 202, see FIG. 2. It should be noted that it is also possible to use other grades of aluminum, as long as the chemical composition of the material described below is achieved. In accordance with one or more embodiments of the invention, the melt is subsequently heated to 900° C., and additives are introduced into the melt to achieve certain predetermined concentrations.

In accordance with one or more embodiments of the invention, the following additives are introduced into the heated melt in step 203 to achieve an additive concentration in the range indicated next to the respective additive:
a. Iron (Fe) at concentration between 0.1 and 12 wt. %;
b. Selenium (Se) at concentration between 0.1 and 12 wt. %;
c. Tellurium (Te) at concentration between 0.1 and 12 wt. %; and
d. Zirconium (Zr) at concentration between 0.1 and 12 wt. %.

In one or more embodiments, a. through d. above summed up represent less than 49 wt. % of the melt, and all other elements (except for aluminum) together comprise less than 1 wt. % of the melt.

In accordance with one or more embodiments of the invention, the aforesaid additives are introduced into the melt not in their pure form, but as part of compositions and/or alloys. This may facilitate the dissolution of the respective additives in the melt and result in a higher degree of homogeneity of the melt.

In one embodiment of the inventive technique, one or more of the aforesaid additives are introduced into the melt in a solid powder form. In an alternative embodiment, the additives may be introduced in a pre-melted form. To facilitate attaining the proper homogeneity of the resulting melt, in one or more embodiments, the stirring mechanism may be used in the reactor 100 to perform mixing in of the additives in step 204, see FIG. 2.

In accordance with one or more embodiments of the invention, once suitably homogeneous melt is obtained, oxygen is introduced into the melt, see step 205. In one or more embodiments, oxygen is introduced through melt's surface by means of diffusion. In another embodiment, oxygen is injected into the melt using an injector. Finally, in an alternative embodiment, oxygen is introduced into the melt through introducing a composition or compositions of oxygen with one or more of the following chemical elements: Iron (Fe), Selenium (Se), Tellurium (Te), and Zirconium (Zr).

In accordance with one or more embodiments of the invention, oxygen is introduced up to a concentration of 5 wt. %. Once oxygen is introduced and reaches the indicated concentration, the synthesis of nanofibers takes place either on the surface of the melt or on a boundary between the molten aluminum and another medium. In one or more embodiments, the grown monocrystalline alumina Al₂O₃ nanofibers are harvested from the surface of the molten metallic aluminum or from the boundary of the molten metallic aluminum and another medium. In accordance with one or more embodiments of the invention, the synthesis of the monocrystalline alumina Al₂O₃ nanofibers is performed within temperature range of the molten metallic aluminum from 660° C. to 1000° C. Finally, the aluminum nanofibers are collected at step 206. In one or more embodiments, the aluminum nanofibers are synthesized in gamma phase. In various alternative embodiments, the alumina nanofibers may be synthesized in Ksi (Xi) phase or other phases, depending on the specific parameters of the synthesis process.

In accordance with one or more embodiments of the invention, it order to insure continuous nanofiber synthesis process, it is desirable to provide a steady supply of oxygen to the reactor to maintain oxygen concentration within desired limits. In addition, the chemical composition of the melt and the temperature should also be appropriately maintained within proper limits during the synthesis process.

As the alumina nanofibers are formed on the surface of the melt during the synthesis process, they can be harvested from the melt's surface. The diameter of the produced nanofibers can be controlled through the parameters of the synthesis process, such as temperature and chemical composition of the melt. On the other hand, the length of the produced nanofibers is determined by synthesis time. In one or more embodiments, the nanofiber synthesis speed may vary from 0.01 mm/hour to 100 mm/hour. It should be noted that the described method may also be utilized to synthesize polycrystalline alumina nanofibers by changing the synthesis conditions during the synthesis process and/or by applying an external action on the surface of the molten aluminum.

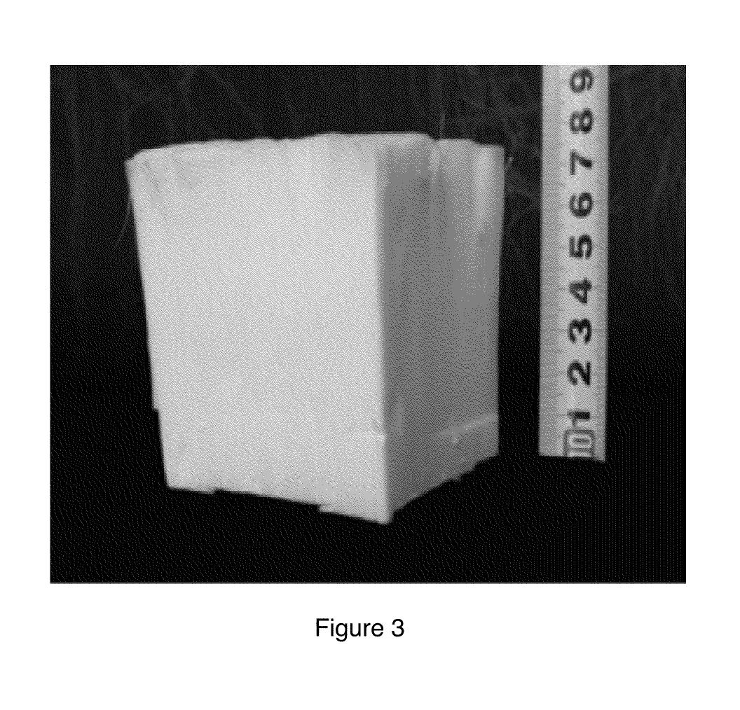

The alumina nanofibers produced according to techniques described above form a mat-like structure shown in FIG. 3. In the aforesaid nanofiber structure, the alumina nanofibers are all oriented in the same transverse direction. Also, in the described structure, the nanfibers are pre-dispersed. In accordance with one or more embodiments, the pre-dispersed co-oriented nanofibers are combined with the cement base and, if applicable, the additive(s). In various embodiments, this can be accomplished by means of water-dispersion of the alumina nanofibers and combining the resulting dispersed nanofiber solution with the cement base and, if applicable, one or more additives. Additionally or alternatively, the alumina nanofibers with or without the cement base may be subject to mechanical or/and ultrasound coarse dispersing. Finally, the resulting nanocomposite material is subjected to the conventional fabrication techniques to manufacture the final composite product.

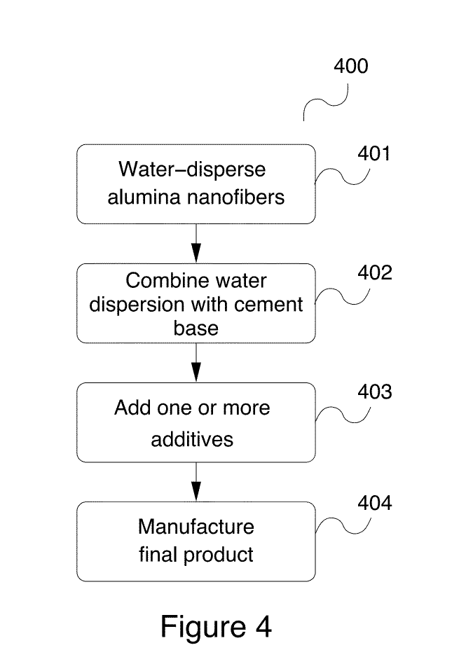

FIG. 4 illustrates an exemplary embodiment of a method 400 for producing a nanocomposite cement-based material reinforced by unidirectionally oriented pre-dispersed alumina nanofibers. First, at step 401, alumina nanofibers are dispersed by means of water dispersion. At step 402, the resulting water dispersion is combined with the cement base. At step 403, one or more additives are added. Finally, at step 404 the product is manufactured using conventional manufacturing techniques.

In various embodiments, the composition of the nanofibers in the cement-based composite material may range from above zero to 100 wt. %. In one or more embodiments, the composition ranged between 1 wt. % and 10 wt. %. It has been shown that the described addition of the pre-dispersed co-oriented nanofibers to cement-based materials results in substantial increase of tensile strength as well as elongation-to-break properties thereof, the effect that has not been seen in case of the use of CNTs for reinforcement. The explanation for this pronounced effect of the reinforcing alumina nanofibers on the tensile strength as well as elongation-to-break properties of cement-based materials lies in the surface properties of alumina nanofibers, which were found to easily be able to adhere to cement particles.

As would be appreciated by persons of ordinary skill in the art, because the content of the alumina nanofibers in the resulting cement-based material is relatively low (usually less than 10%), the industrial processes for utilizing the resulting cement-based composite materials remains largely unchanged.

Moreover, other implementations of the invention will be apparent to those skilled in the art from consideration of the specification and practice of the invention disclosed herein. Various aspects and/or components of the described embodiments may be used singly or in any combination in the process for manufacturing cement-based nanofiber reinforced materials. It is intended that the specification and examples be considered as exemplary only, with a true scope and spirit of the invention being indicated by the following claims.

What is claimed is:

1. A method for producing a cement-based material reinforced by co-oriented alumina Al₂O₃ nanofibers, the method comprising combining a plurality of co-oriented alumina Al₂O₃ nanofibers with a cement base.

2. The method of claim 1, further comprising subjecting the combined co-oriented alumina Al₂O₃ nanofibers and the cement base to an ultrasound to facilitate dispersion of the alumina Al₂O₃ nanofibers.

3. The method of claim 1, further comprising adding one or more additives to the combined co-oriented alumina Al₂O₃ nanofibers and the cement base.

4. The method of claim 1, wherein the cement-based material is a concrete.

5. The method of claim 1, wherein the cement-based material is a mortar.

6. The method of claim 1, wherein the cement-based material is a grout.

7. The method of claim 1, wherein combining a plurality of co-oriented alumina Al₂O₃ nanofibers with a cement base comprises water-dispersing the a plurality of co-oriented alumina Al₂O₃ nanofibers and combining the resulting dispersion with the cement base.

8. The method of claim 1, wherein combining a plurality of co-oriented alumina Al₂O₃ nanofibers with a cement base comprises mechanical mixing the plurality of co-oriented alumina Al₂O₃ nanofibers with the cement base.

9. A cement-based material reinforced by co-oriented alumina Al₂O₃ nanofibers prepared by a process comprising combining a plurality of co-oriented alumina Al₂O₃ nanofibers with a cement base.

10. The cement-based material of claim 9, wherein the process further comprises subjecting the combined co-oriented alumina Al₂O₃ nanofibers and the cement base to an ultrasound to facilitate dispersion of the alumina Al₂O₃ nanofibers.

11. The cement-based material of claim 9, wherein the process further comprises adding one or more additives to the combined co-oriented alumina Al₂O₃ nanofibers and the cement base.

12. The cement-based material of claim 9, wherein the cement-based material is a concrete.

13. The cement-based material of claim 9, wherein the cement-based material is a mortar.

14. The cement-based material of claim 9, wherein the cement-based material is a grout.

15. The cement-based material of claim 9, wherein combining a plurality of co-oriented alumina Al₂O₃ nanofibers with a cement base comprises water-dispersing the a plurality of co-oriented alumina Al₂O₃ nanofibers and combining the resulting dispersion with the cement base.

16. The cement-based material of claim 9, wherein combining a plurality of co-oriented alumina Al₂O₃ nanofibers with a cement base comprises mechanical mixing the plurality of co-oriented alumina Al₂O₃ nanofibers with the cement base.

17. A cement-based material reinforced by co-oriented alumina Al₂O₃ comprising a cement base combined with a plurality of co-oriented alumina Al₂O₃ nanofibers.

18. The cement-based material of claim 17, further comprising one or more additives.

19. The cement-based material of claim 17, wherein the cement-based material is a concrete.

20. The cement-based material of claim 17, wherein the cement-based material is a mortar.
